(19) United States
(12) Patent Application Publication
(10) Pub. No.: US 2015/0082051 A1
(43) Pub. Date: Mar. 19, 2015

(54) Method for Formatting and Distributing Electronic Data

(71) Applicants: Ankur Aggarwal, Jersey City, NJ (US); Daniel Arthur Oja, Savannah, GA (US)

(72) Inventors: Ankur Aggarwal, Jersey City, NJ (US); Daniel Arthur Oja, Savannah, GA (US)

(21) Appl. No.: 14/490,292

(22) Filed: Sep. 18, 2014

Related U.S. Application Data
(60) Provisional application No. 61/879,537, filed on Sep. 18, 2013.

(51) Int. Cl. G06F 9/54; G06F 21/60

(52) U.S. Cl. CPC G06F 9/546; G06F 21/602
USPC 713/189; 719/319

(57) ABSTRACT

A method for formatting and distributing electronic data through a middleware system. A data unit received by the middleware system from an originating system is converted into a formatted data unit and forwarded to a primary destination system. A primary destination identification is retrieved from an information table of the data unit. The primary destination identification is compared to a destination identification in a register of destination systems for a plurality of destination systems. If the primary destination identification matches the destination identification of one of the plurality of destination systems, then formatting specifics for the primary destination system are retrieved from the register of destination systems. The data unit is then converted into the formatted data unit according to the formatting specifics of the primary destination system and the formatted data unit is sent to the primary destination system. Methods for encrypting, decrypting, and authenticating data are also employed.

The current application claims a priority to the U.S. Provisional Patent application Ser. No. 61/879,537 filed on Sep. 18, 2013.

### FIELD OF THE INVENTION

The present invention relates generally to middleware systems and electronic learning (e-learning) systems. More specifically, the present invention is a middleware system and method for receiving, formatting, and forwarding data between multiple e-learning platforms and systems.

### BACKGROUND OF THE INVENTION

The development of electronic information and communication technology has led to corresponding rapid development in e-learning systems. It is now possible for instructors, educational institutions, and publishers to deliver educational material to students directly on a variety of devices. Students are able to electronically review course material, complete assignments, submit assignments, and review grades earned in a course. E-learning particularly caters to distance learning, flexible learning, and students who prefer self-paced learning. As can be imagined, e-learning systems often have large user bases that generate large amounts of data. Because of the nature of educational systems, data such as student test scores and homework scores must be transferred. For example, students who complete assignments on a publisher or content creator's systems are given scores that must be forwarded to their instructors. In the early days of e-learning systems, content and data was typically hosted on a Sharable Content Object Reference Model (SCORM)-based learning management system (LMS). In these older SCORM-based LMSs, data transfer was rather straightforward due to the fact that content results such as assignment scores were forwarded directly to the LMS on which the content was hosted. However, the emergence of new technologies has exposed limitations in the conventional SCORM-based model. For example, content that is run locally by a user on a platform such as a tablet computer, desktop computer, or smartphone cannot send results to a SCORM-based LMS as the content is hosted on an external platform rather than the LMS. The Tin Can Applied Programming Interface (API), also known as “The Experience API”, allows Learning Record Stores (LRS) to accept data and activity streams from various types of external originating systems as well as sources such as local applications. Educational content is created by publishers and other content creators such as, but not limited to, book publishers and their instructional content developers, educational instructors, and educational institutions. This allows publishers to create content from which users may generate results that are sent back to a specific LRS. The LRS is generally designated by an instructor or institution and is the destination system through which the instructor or institution wishes to receive results from publisher-created content. However, the Tin Can API itself is limited when a large and diverse user base of learners, instructors, and institutions generates data that must be transmitted to a similarly diverse group of destinations. Under the Tin Can API, in order to accommodate the user base, publishers are required to create customized content through which users may send results back to their individual institutions, a solution that is both impractical and unfeasible. The problem may be exacerbated due to possible data format incompatibilities between involved systems during a data transfer. The present invention seeks to address the issue regarding data transmission and delivery to multiple types of destination systems through a variety of communication protocols.

The present invention is a middleware system and method for receiving, formatting, and forwarding data from an originating e-learning system to a destination e-learning system. The present invention overcomes the limitations of conventional e-learning systems by accommodating a widely diverse user base of learners, instructors, and institutions utilizing an equally diverse group of destination systems. The present invention allows publishers to create e-learning content through which users may generate and transmit data to a wide variety of destinations specified by instructors or institutions. In the preferred embodiment of the present invention, the system is capable of accepting data from a variety of originating systems such as digital books, web-based assignments, localized applications, and similar online content created by publishers. The system comprises a register of all destination systems to which the incoming data may be forwarded. New destination systems may be added to the register as needed and the system stores specifications relating to all destination systems listed in the register. Prior to data transfer, an instructor or institution creates an instructor account, which specifies the destination system to which the data is to be forwarded and the format in which said data can be accepted. After the system has received the incoming data, the system retrieves the relevant specifications pertaining to the designated destination system. The specifications allow the system to appropriately format the data for the destination system with no additional input from the learner, instructor, or institution. Properly formatted data may be forwarded to one or more destination systems as needed. The data may be encrypted and anonymized as well during the formatting process.

The present invention facilitates content creation for publishers as the publishers are not required to design content to accommodate multiple known and/or unknown destination systems to which data generated from their content is to be transferred. Publishers create one version of the content and said content utilizes the middleware system to forward the results to the appropriate destination. Furthermore, the system of the present invention minimizes the actions required from learners, instructors, and institutions as the system is able to directly analyze incoming data in order to properly accommodate the destination system designated by the instructor or institution. It is important to note that the system of the present invention does not store data generated from e-learning content. Rather, the present invention serves to streamline and otherwise facilitate the data transfer process.

### BRIEF DESCRIPTION OF THE DRAWINGS

FIG. 1 is a flowchart depicting the overall method for formatting and distributing a data unit to a primary destination system through a middleware system;

FIG. 2 is a flowchart thereof, further depicting the process of handling an encrypted data unit;

FIG. 3 is a flowchart thereof, further depicting the authentication process for a data unit;

FIG. 4 is a flowchart thereof, further depicting the process of formatting the data unit by encrypting the formatted data unit;

FIG. 5 is a flowchart thereof, further depicting the process of formatting the data unit by anonymizing the formatted data unit;

FIG. 6 is a flowchart thereof, further depicting the process for sending the formatted data unit to the primary destination system;

FIG. 7 is a flowchart thereof, further depicting the process of receiving and sending a message receipt for the formatted data unit;

FIG. 8 is a flowchart thereof, further depicting the process of echoing the data unit to a secondary destination system;

FIG. 9 is a flowchart thereof, further depicting the process of formatting the data unit by encrypting the second formatted data unit;

FIG. 10 is a flowchart thereof, further depicting the process of formatting the data unit by anonymizing the second formatted data unit;

FIG. 11 is a flowchart thereof, further depicting the process for sending the second formatted data unit to the secondary destination system; and

FIG. 12 is a flowchart thereof, further depicting the process of receiving and sending a message receipt for the second formatted data unit.

FIG. 13 is a diagram depicting the flow of data from a plurality of originating systems to a plurality of destination systems through the middleware system.

FIG. 14 is a diagram depicting an information table for the data unit received from an originating system; and

FIG. 15 is a diagram thereof, further depicting a publisher identification and publisher secret key included in the publisher info.

FIG. 16 is a diagram depicting an input field for adding a new instructor to the middleware system.

FIG. 17 is a diagram depicting an input field for adding a new destination system to the register of destination systems.

FIG. 18 is a flowchart providing the method of the present invention in an example application.

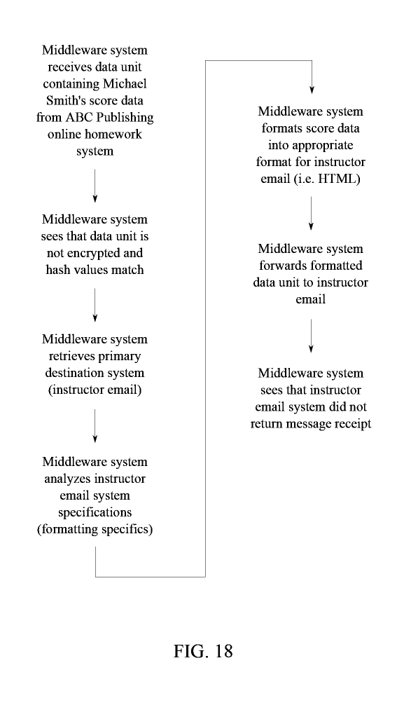

### DETAIL DESCRIPTIONS OF THE INVENTION

All illustrations of the drawings are for the purpose of describing selected versions of the present invention and are not intended to limit the scope of the present invention.

The present invention is a method for formatting and distributing data units through a middleware system 20. The present invention seeks to provide a means of seamlessly transferring data from an originating system 11 to a destination system. The present invention and the middleware system 20 is configured to be operated between academic systems, facilitating the data transfer process for learners, instructors, and institutions; however, it is possible for the present invention and the middleware system 20 to be used in any other online environment requiring the transfer of data, including, but not limited to, data from environmental sensors, usage data, or activity streams.

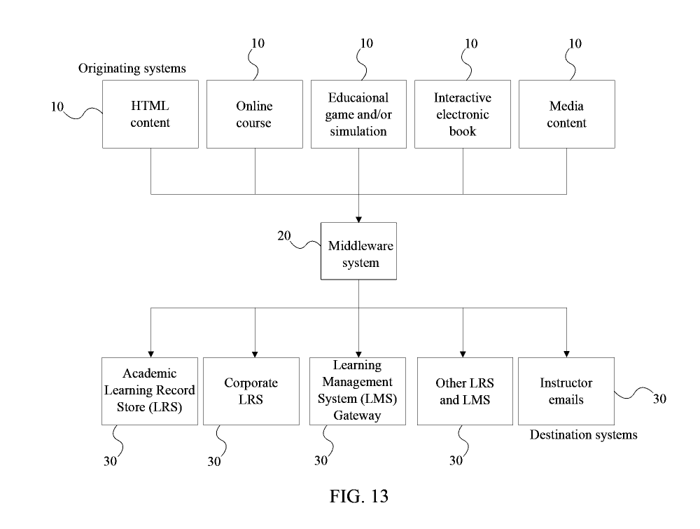

In reference to FIG. 13, the middleware system 20 is a computing device, such as a server or multiple servers, that receives data units from a plurality of originating systems 10 and directs the data units to a plurality of destination systems 30. Similar to the middleware system 20, each of the plurality of originating systems 10 and each of the plurality of destination systems 30 is a computing device, such as a server or multiple servers. The middleware system 20 receives the data units from the plurality of originating systems 10, formats the data units as specified by the appropriate destination system from the plurality of destination systems 30, and sends the formatted data units to the appropriate destination systems.

Each of the plurality of originating systems 10 supports software for online courses, online curriculums, educational games, electronic books, media content, etc. The middleware system 20 is capable of receiving data units from the plurality of originating systems 10 through a variety of supported protocols including, but not limited to, Hypertext Transfer Protocol (HTTP) methods such as POST and GET, Simple Object Access Protocol (SOAP), and Tin Can. Data units may include information in regards to audio, video, homework scores, test scores, activity/event statements that are generated through software running on the plurality of originating systems 10, or any other desired type of content.

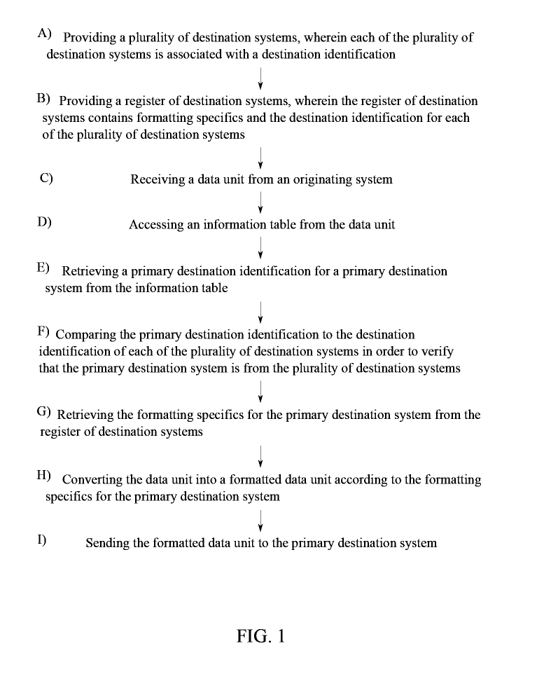

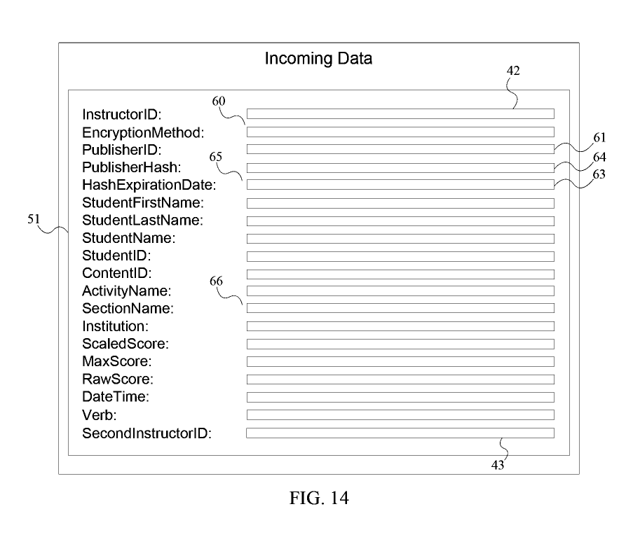

In reference to FIG. 14, each of the data units is provided with an information table 51 that contains information pertaining to the data being transferred in order to determine the type of data being transferred, the destination system, the required format for the destination system, and other relevant information. In reference to FIG. 1, when the middleware system 20 receives a data unit 50 from an originating system 11 of the plurality of originating systems 10, the middleware system 20 accesses the information table 51 from the data unit 50 in order to retrieve a primary destination identification 42 for a primary destination system 31 from the information table 51 of the data unit 50.

The primary destination identification 42 is a unique string used to retrieve the primary destination system 31 to which the data unit 50 is to be forwarded. In reference to FIG. 14, incoming data units would typically include a number of additional fields. For example, the information table 51 for the data unit 50 pertaining to educational information may include the following source data 66:

Student information, such as a student's first and last name, full name, and a student identification being a unique string pertaining to the student, such as an email address;

A content identification for the system or product generating the data unit 50 (e.g. course name);

An activity name providing more specific information relating to the purpose of the data unit 50 (e.g. assignment name);

A section name being an identification or code relating to a course, class, etc.;

An institution the student is affiliated with, various test scores (e.g. a scaled score, max score, raw score); and

A date/time to indicate the date and time of completion of the activity, and a verb to indicate the status of the activity (e.g. complete, incomplete, pass, fail).

The source data 66 can also include any other information being sent from the originating system 11.

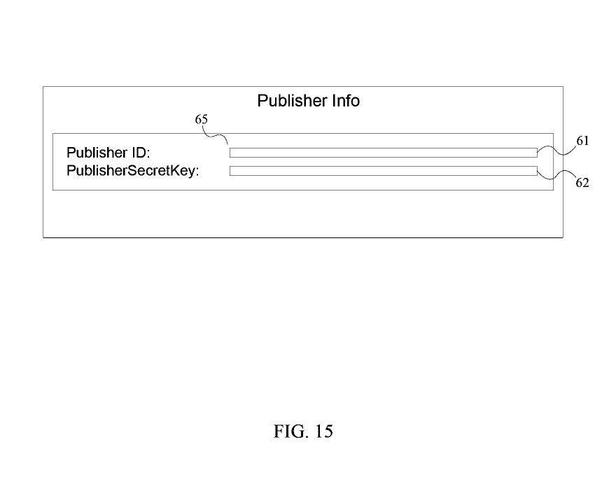

Furthermore, in reference to FIG. 14-15, if the data unit 50 is encrypted by the originating system 11, then the information table 51 may include the following originating encryption information being information needed to decrypt and forward the data:

An encryption method to signal the type of encryption applied to the source data 66 in the information table 51 of the data unit 50 sent from the originating system 11;

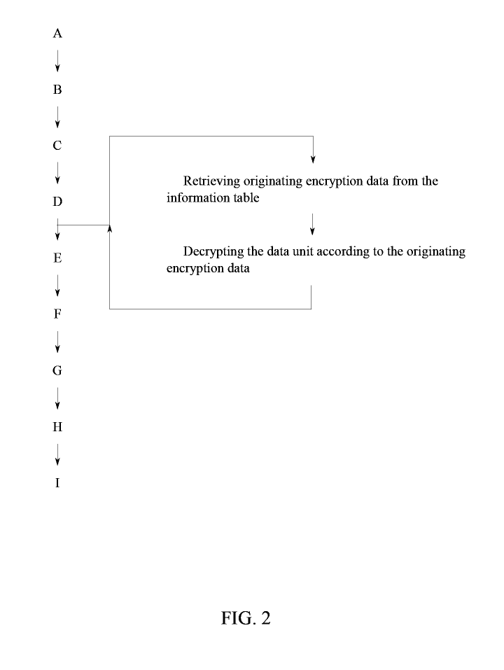

In reference to FIG. 2, if the source data 66 of the data unit 50 is encrypted, then the middleware system 20 retrieves the originating encryption data 60 from the information table 51 and decrypts the source data 66 of the data unit 50 according to the originating encryption data 60. More specifically, the middleware system 20 decrypts the source data 66 of the data unit 50 according to the encryption method specified in the information table 51.

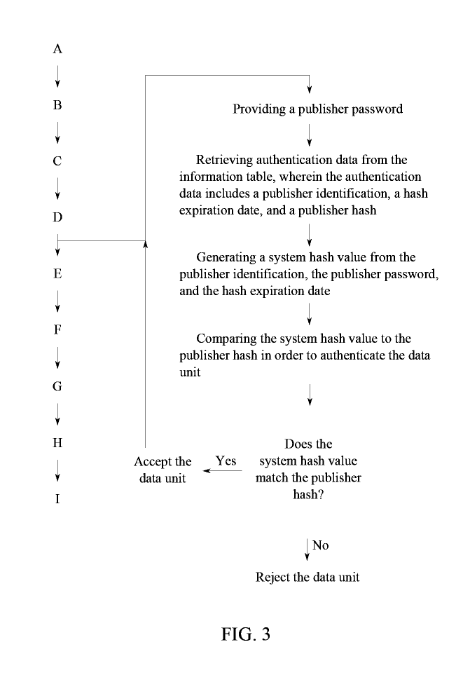

In reference to FIG. 3, the data unit 50 may also require authentication to verify that the data unit 50 is from a trusted source. As such, a publisher secret key 62 may be stored on the middleware system 20 for the originating system 10, while the information table 51 may further include the following authentication information 65:

A publisher identification 61 for the creator of the data unit 50, such as a software name or company name;

A publisher hash 64 being a non-encrypted hash value provided by the creator of the data unit 50 in order to verify that the data unit 50 originates from an authorized source; and

A hash expirations date being the non-encrypted date on which the publisher hash 64 is set to expire.

In reference to FIG. 3, if authentication is required, the middleware system 20 retrieves the authentication information 65 from the information table 51 and generates a system hash value 70 from the publisher identification 61, the publisher secret key 62, and the hash expiration date 63. The middleware system 20 then compares the system hash value 70 to the publisher hash 64 in order to authenticate the data unit 50. If the system hash value 70 matches the publisher hash 64, then the middleware system 20 accepts the data unit 50, and if the system hash value 70 does not match the publisher hash 64, then the middleware system 20 rejects the data unit 50.

In reference to FIG. 1, the primary destination identification 42 is retrieved from the information table 51 by the middleware system 20. A register of destination systems 40 is stored on the middleware system 20, wherein the register of destination systems 40 includes a destination identification 41 for each of the plurality of destination systems 30 registered with the middleware system 20. The destination identification 41 for each of the plurality of destination systems 30 being a unique string associated with an instructor, university, system, etc. Additionally, the register of destination systems 40 includes formatting specifics 44 for each of the plurality of destination systems 30. The middleware system 20 accesses the register of destination systems 40 in order to compare the primary destination identification 42 from the information table 51 of the data unit 50 to the destination field of each of the plurality of destination systems 30.

In further reference to FIG. 1, the middleware system 20 compares the primary destination identification 42 to the destination identification 41 of each of the plurality of destination systems 30 in order to verify that the primary destination system 31 is from the plurality of destination systems 30 registered with the middleware system 20. If the primary destination system 31 is not registered with the middleware system 20 (i.e. the primary destination identification 42 is not found in the register of destination systems 40), then the middleware system 20 rejects the data unit 50 and sends an error message to the originating system 11. If the primary destination system 31 is registered with the middleware system 20, then the middleware system 20 retrieves the formatting specifics 44 for the primary destination system 31 from the register of destination systems 40.

Further referencing FIG. 1, once the middleware system 20 retrieves the formatting specifics 44 for the primary destination system 31, the middleware system 20 converts the data unit 50 into a formatted data unit 80 according to the formatting specifics 44 for the primary destination system 31. The conversion of the data unit 50 into the formatted data unit 80 may include processes for encrypting and anonymizing the formatted data unit 80. As such, the formatting specifics 44 for the primary destination system 31 may contain destination encryption data 45 or anonymization data 47, respectively.

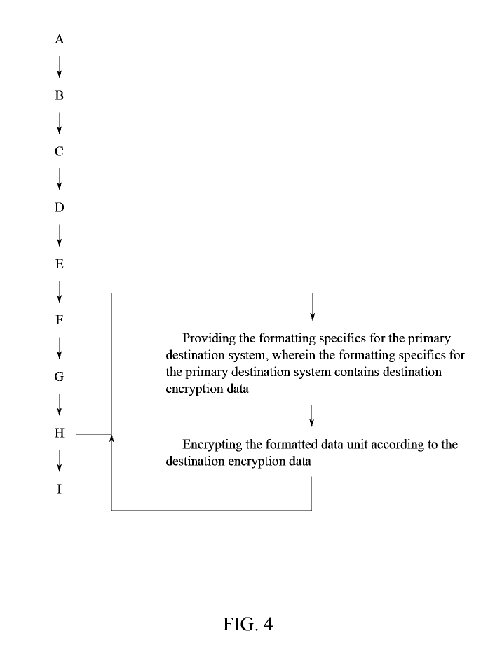

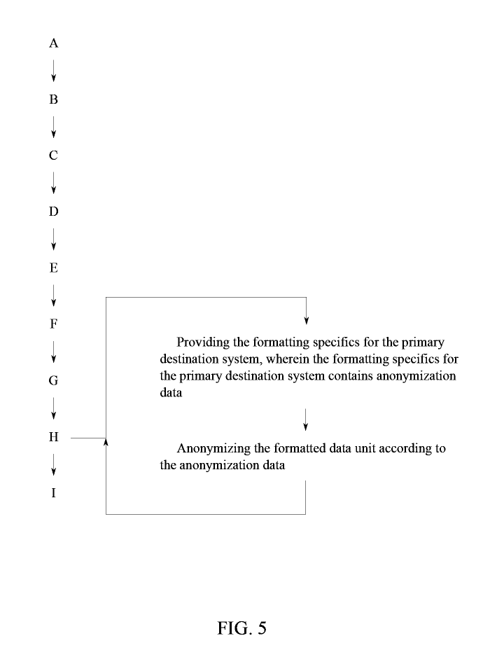

In reference to FIG. 4, if the formatting specifics 44 for the primary destination system 31 call for the data unit 50 to be encrypted, then the middleware system 20 encrypts the formatted data unit 80 according to the destination encryption data 45. Similarly, in reference to FIG. 5, if the formatting specifics 44 for the primary destination system 31 call for the data unit 50 to be anonymized, then the middleware system 20 anonymizes the formatted data unit 80 according to the anonymization data 47. Because the register of destination systems 40 contains the formatting specifics 44 for the primary destination system 31, no further input from learners, instructors, and institutions is required during the data formatting and forwarding process.

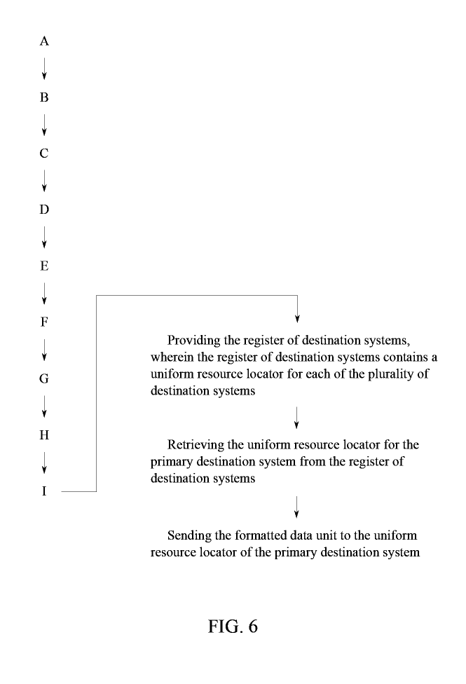

Once the formatted data unit 80 is ready, the middleware system 20 then sends the formatted data unit 80 to the primary destination system 31, as shown in FIG. 1. In reference to FIG. 6, the register of destination systems 40 further includes a uniform resource locator 48 for each of the plurality of destination systems 30 to which data units are sent. As such, the uniform resource locator 48 for the primary destination system 31 is retrieved from the register of destination systems 40 by the middleware system 20. The middleware system 20 then sends the formatted data unit 80 to the uniform resource locator 48 of the primary destination system 31. The middleware system 20 may send the formatted data unit 80 to the primary destination system 31 through a variety of protocols, such as HTTP methods such as POST and GET, SOAP, Short Message Service (SMS), Simple Mail Transfer Protocol (SMTP), and Tin Can.

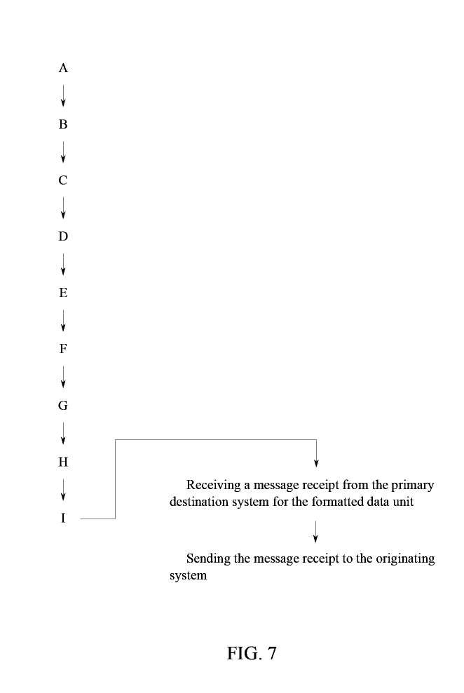

In reference to FIG. 7, after the formatted data unit 80 has been sent to the primary destination system 31, the middleware system 20 may receive a message receipt 90 from the primary destination system 31 for the formatted data unit 80. The message receipt 90 confirms whether or not the primary destination system 31 successfully received the formatted data unit 80. Once received by the middleware system 20, the message receipt 90 is sent to the originating system 11 by the middleware system 20 in order to confirm that the data unit 50 was successfully forwarded to the primary destination system 31.

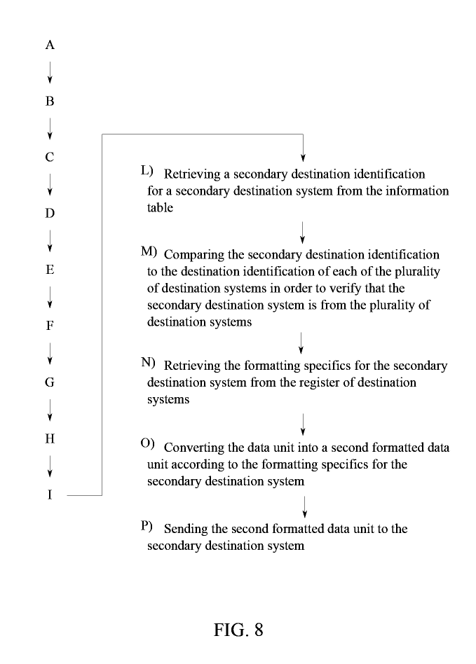

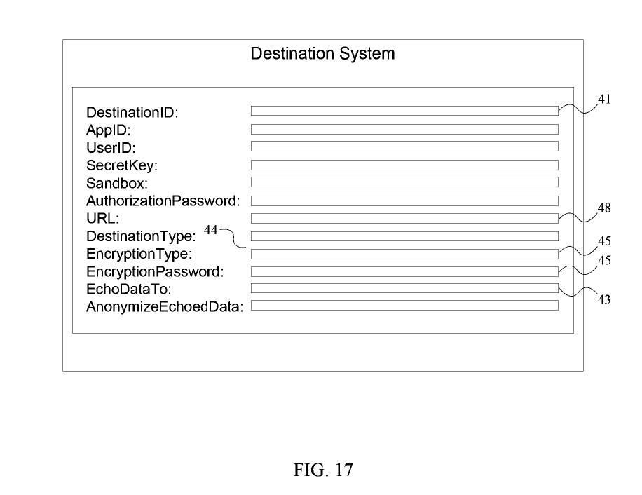

In reference to FIG. 8, the data unit 50 received from the originating system 11 can also be forwarded, or “echoed”, to a secondary destination system 32 in addition to the primary destination system 31. Similar to the primary destination identification 42, a secondary destination identification 43 for the secondary destination system 32 is retrieved from the information table 51 by the middleware system 20. Alternatively, the secondary destination identification 43 can be retrieved from the register of destination systems 40, wherein the secondary destination identification 43 is stored with the destination identification 41 in a destination system table, as shown in FIG. 17. In this way, when the destination identification 41 is initially retrieved and used to access the destination system table from the register of destination systems 40, the secondary destination identification 43 is accessed as well. The middleware system 20 then accesses the register of destination systems 40 in order to compare the secondary destination identification 43 from the information table 51 of the data unit 50 to the destination field of each of the plurality of destination systems 30.

In further reference to FIG. 8, the middleware system 20 compares the secondary destination identification 43 to the destination field of each of the plurality of destination systems 30 in order to verify that the secondary destination system 32 is from the plurality of destination systems 30 registered with the middleware system 20. If the secondary destination system 32 is not registered with the middleware system 20 (i.e. the secondary destination identification 43 is not found in the register of destination systems 40), then the middleware system 20 rejects the data unit 50 and sends an error message to the originating system 11. If the secondary destination system 32 is registered with the middleware system 20, then the middleware system 20 retrieves the formatting specifics 44 for the secondary destination system 32 from the register of destination systems 40.

Further referencing FIG. 8, once the middleware system 20 retrieves the formatting specifics 44 for the secondary destination system 32, the middleware system 20 converts the data unit 50 into a second formatted data unit 82 according to the formatting specifics 44 for the secondary destination system 32. Similar to the formatting specifics 44 for the primary destination system 31, the conversion of the data unit 50 into the second formatted data unit 82 may include processes for encrypting and anonymizing the second formatted data unit 82. As such, the formatting specifics 44 for the secondary destination system 32 may contain secondary destination encryption data 46 or anonymization data 47, respectively.

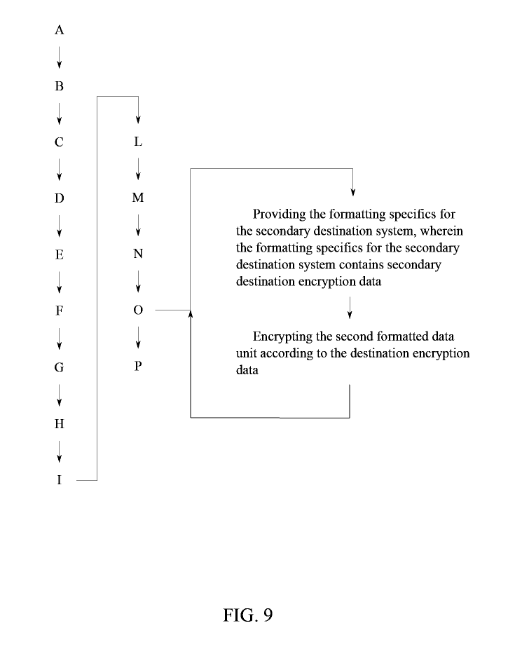

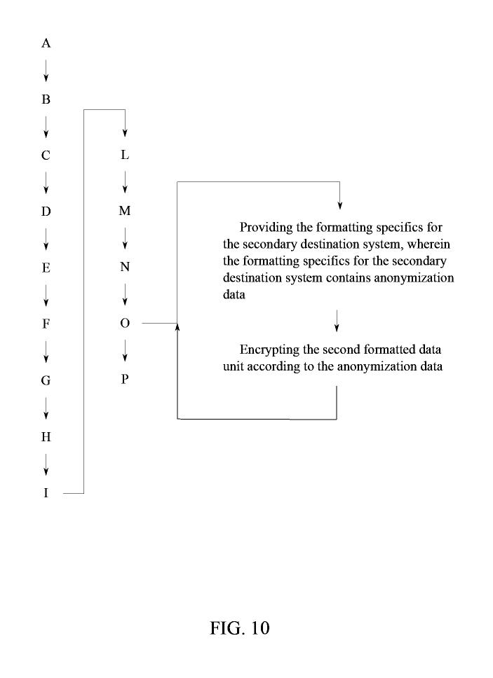

In reference to FIG. 9, if the formatting specifics 44 for the secondary destination system 32 call for the data unit 50 to be encrypted, then the middleware system 20 encrypts the second formatted data unit 82 according to the secondary destination encryption data 46. Similarly, in reference to FIG. 10, if the formatting specifics 44 for the secondary destination system 32 call for the data unit 50 to be anonymized, then the middleware system 20 anonymizes the second formatted data unit 82 according to the anonymization data 47. Because the register of destination systems 40 contains the formatting specifics 44 for the secondary destination system 32, no further input from learners, instructors, and institutions is required during the data formatting and forwarding process.

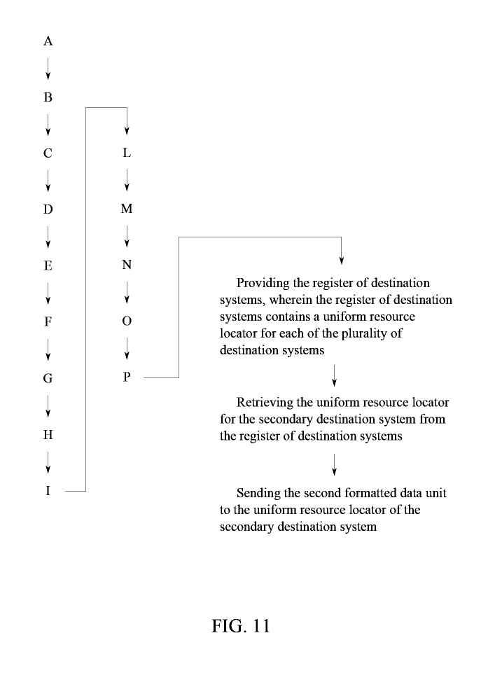

Once the second formatted data unit 82 is ready, the middleware system 20 then sends the second formatted data unit 82 to the secondary destination system 32, as shown in FIG. 8. More specifically, in reference to FIG. 11, the uniform resource locator 48 for the secondary destination system 32 is first retrieved from the register of destination systems 40 by the middleware system 20. The middleware system 20 then sends the second formatted data unit 82 to the uniform resource locator 48 of the secondary destination system 32. The middleware system 20 may send the second formatted data unit 82 to the secondary destination system 32 through a variety of protocols, such as the aforementioned POST, GET, SOAP, SMS, SMTP, and Tin Can.

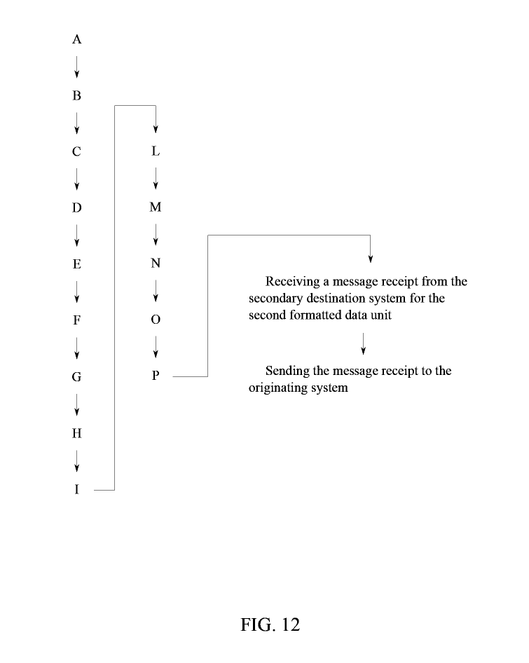

In reference to FIG. 12, after the second formatted data unit 82 has been sent to the secondary destination system 32, the middleware system 20 may receive a message receipt 90 from the secondary destination system 32 for the second formatted data unit 82. The message receipt 90 confirms whether or not the secondary destination system 32 successfully received the second formatted data unit 82. Once received by the middleware system 20, the message receipt 90 is sent to the originating system 11 by the middleware system 20 in order to confirm that the data unit 50 was successfully forwarded to the secondary destination system 32.

The ability for the data unit 50 to be echoed to other destination systems can be very beneficial, especially when the data unit 50 is anonymized. For example, the middleware system 20 may forward data pertaining to e-learning content created by publishers to allow publishers to gain an understanding of how learners, instructors, and institutions utilize their content. This allows the publishers to streamline future published content by eliminating features that are unused or underused. Conversely, the publishers may focus and place emphasis on content that is widely used by the user base.

New destination systems can be added to the register of destination systems 40 as needed. In reference to FIG. 17, a new destination system is added by entering the destination identification 41 and the uniform resource locator 48 for the new destination system into the register of destination systems 40 through the middleware system 20. In addition to the formatting specifics 44, the destination identification 41, and the uniform resource locator 48 for each of the plurality of destination systems 30, the register of destination systems 40 may contain any other information pertaining to the plurality of destination systems 30.

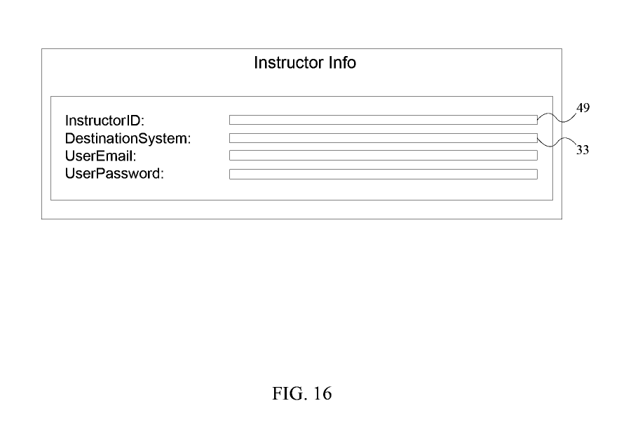

In reference to FIG. 16, new instructors can be added to the middleware system 20 as needed. The destination identification 41 for the new instructor is added to the input field and is used to redirect incoming data to a specific destination system 33 from the plurality of destination systems 30. For example, students can submit data to the destination identification 41 for the new instructor, such as an e-mail address. The destination identification 41 for the new instructor is linked to the specific destination system 33 from the plurality of destination systems 30, which allows the formatting specifics 44 for the specific destination system 33 to be retrieved in order to format the data and direct the data to the specific destination system 33. A user email and a user password may also be included when adding the destination identification 41 for the new instructor in order to contact the owner (i.e. the new instructor) of the destination identification 41 or to authenticate the owner in order to update information in regards to the destination identification 41 or the specific destination system 33.

The object of the present invention is to eliminate uncertainty regarding the destinations of data generated from publisher-created content (particularly e-learning content), as well as increase flexibility in transferring data to multiple destination systems using a variety of communication protocols and systems. The present invention facilitates content creation for publishers, as publishers are often required to accommodate for the various systems used by a diverse user base. The present invention is able to overcome data incompatibilities between originating systems and destination systems as well with no additional input from learners, instructors, and institutions.

Although the invention has been explained in relation to its preferred embodiment, it is to be understood that many other possible modifications and variations can be made without departing from the spirit and scope of the invention as hereinafter claimed.

What is claimed is:

1. A method for formatting and distributing electronic data by executing computer-executable instructions stored on a non-transitory computer-readable medium, the method comprises the steps of:
providing a plurality of destination systems, wherein each of the plurality of destination systems is associated with a destination identification;
providing a register of destination systems, wherein the register of destination systems contains formatting specifics and the destination identification for each of the plurality of destination systems;
receiving a data unit from an originating system;
accessing an information table from the data unit;
retrieving a primary destination identification for a primary destination system from the information table;
comparing the primary destination identification to the destination identification of each of the plurality of destination systems in order to verify that the primary destination system is from the plurality of destination systems;
retrieving the formatting specifics for the primary destination system from the register of destination systems;
converting the data unit into a formatted data unit according to the formatting specifics for the primary destination system; and
sending the formatted data unit to the primary destination system.

2. The method for formatting and distributing electronic data by executing computer-executable instructions stored on a non-transitory computer-readable medium, the method as claimed in claim 1 further comprises the steps of:
retrieving originating encryption data from the information table; and
decrypting the data unit according to the originating encryption data.

3. The method for formatting and distributing electronic data by executing computer-executable instructions stored on a non-transitory computer-readable medium, the method as claimed in claim 1 further comprises the steps of:
providing a publisher secret key;
retrieving authentication data from the information table, wherein the authentication data includes a publisher identification, a hash expiration date, and a publisher hash;
generating a system hash value from the publisher identification, the publisher secret key, and the hash expiration date; and
comparing the system hash value to the publisher hash in order to authenticate the data unit.

4. The method for formatting and distributing electronic data by executing computer-executable instructions stored on a non-transitory computer-readable medium, the method as claimed in claim 1 further comprises the steps of:
providing the register of destination systems, wherein the register of destination systems contains a uniform resource locator for each of the plurality of destination systems;
retrieving the uniform resource locator for the primary destination system from the register of destination systems; and
sending the formatted data unit to the uniform resource locator of the primary destination system.

5. The method for formatting and distributing electronic data by executing computer-executable instructions stored on a non-transitory computer-readable medium, the method as claimed in claim 1 further comprises the steps of:
providing the formatting specifics for the primary destination system, wherein the formatting specifics for the primary destination system contains destination encryption data; and
encrypting the formatted data unit according to the destination encryption data.

6. The method for formatting and distributing electronic data by executing computer-executable instructions stored on a non-transitory computer-readable medium, the method as claimed in claim 1 further comprises the steps of:
providing the formatting specifics for the primary destination system, wherein the formatting specifics for the primary destination system contains anonymization data; and
anonymizing the formatted data unit according to the anonymization data.

7. The method for formatting and distributing electronic data by executing computer-executable instructions stored on a non-transitory computer-readable medium, the method as claimed in claim 1 further comprises the steps of:
receiving a message receipt from the primary destination system for the formatted data unit; and
sending the message receipt to the originating system.

8. The method for formatting and distributing electronic data by executing computer-executable instructions stored on a non-transitory computer-readable medium, the method as claimed in claim 1 further comprises the steps of:
retrieving a secondary destination identification for a secondary destination system from the information table;
verifying the secondary destination identification with the register of destination systems, wherein the secondary destination system is verified to be from the plurality of destination systems;
retrieving the formatting specifics for the secondary destination system from the register of destination systems;
converting the data unit into a second formatted data unit according to the formatting specifics for the secondary destination system; and
sending the second formatted data unit to the secondary destination system.

9. The method for formatting and distributing electronic data by executing computer-executable instructions stored on a non-transitory computer-readable medium, the method as claimed in claim 8 further comprises the steps of:
providing the formatting specifics for the secondary destination system, wherein the formatting specifics for the secondary destination system contains secondary destination encryption data; and
encrypting the second formatted data unit according to the secondary destination encryption data.

10. The method for formatting and distributing electronic data by executing computer-executable instructions stored on a non-transitory computer-readable medium, the method as claimed in claim 8 further comprises the steps of:
providing the formatting specifics for the secondary destination system, wherein the formatting specifics for the secondary destination system contains anonymization data; and
anonymizing the second formatted data unit according to the anonymization data.

11. The method for formatting and distributing electronic data by executing computer-executable instructions stored on a non-transitory computer-readable medium, the method as claimed in claim 8 further comprises the steps of:
providing the register of destination systems, wherein the register of destination systems contains a uniform resource locator for each of the plurality of destination systems;
retrieving the uniform resource locator for the secondary destination system from the register if destination systems; and
sending the second formatted data unit to the uniform resource locator of the secondary destination system.

12. The method for formatting and distributing electronic data by executing computer-executable instructions stored on a non-transitory computer-readable medium, the method as claimed in claim 8 further comprises the steps of:
receiving a message receipt from the secondary destination system for the second formatted data unit; and
sending the message receipt to the originating system.

13. A method for formatting and distributing electronic data by executing computer-executable instructions stored on a non-transitory computer-readable medium, the method comprises the steps of:
providing a plurality of destination systems, wherein each of the plurality of destination systems is associated with a destination identification;
providing a publisher secret key and a register of destination systems, wherein the register of destination systems contains formatting specifics, a uniform resource locator, and the destination identification for each of the plurality of destination systems;
receiving a data unit from an originating system;
accessing an information table from the data unit;
retrieving authentication data from the information table, wherein the authentication data includes a publisher identification, a hash expiration date, and a publisher hash;
generating a system hash value from the publisher identification, the publisher secret key, and the hash expiration date;
comparing the system hash value to the publisher hash in order to authenticate the data unit;
retrieving a primary destination identification for a primary destination system from the information table;
comparing the primary destination identification to the destination identification of each of the plurality of destination systems in order to verify that the primary destination system is from the plurality of destination systems;
retrieving the formatting specifics for the primary destination system from the register of destination systems;
converting the data unit into a formatted data unit according to the formatting specifics for the primary destination system;
retrieving the uniform resource locator for the primary destination system from the register of destination systems; and
sending the formatted data unit to the uniform resource locator of the primary destination system.

14. The method for formatting and distributing electronic data by executing computer-executable instructions stored on a non-transitory computer-readable medium, the method as claimed in claim 13 further comprises the steps of:
retrieving originating encryption data from the information table; and
decrypting the data unit according to the originating encryption data.

15. The method for formatting and distributing electronic data by executing computer-executable instructions stored on a non-transitory computer-readable medium, the method as claimed in claim 13 further comprises the steps of:
providing the formatting specifics for the primary destination system, wherein the formatting specifics for the primary destination system contains destination encryption data; and
encrypting the formatted data unit according to the destination encryption data.

16. The method for formatting and distributing electronic data by executing computer-executable instructions stored on a non-transitory computer-readable medium, the method as claimed in claim 13 further comprises the steps of:
providing the formatting specifics for the primary destination system, wherein the formatting specifics for the primary destination system contains anonymization data; and
anonymizing the formatted data unit according to the anonymization data.

17. The method for formatting and distributing electronic data by executing computer-executable instructions stored on a non-transitory computer-readable medium, the method as claimed in claim 13 further comprises the steps of:
receiving a message receipt from the primary destination system for the formatted data unit; and
sending the message receipt to the originating system.

18. The method for formatting and distributing electronic data by executing computer-executable instructions stored on a non-transitory computer-readable medium, the method as claimed in claim 13 further comprises the steps of:
retrieving a secondary destination identification for a secondary destination system from the information table;
verifying the secondary destination identification with the register of destination systems, wherein the secondary destination system is verified to be from the plurality of destination systems;
retrieving the formatting specifics for the secondary destination system from the register of destination systems;
converting the data unit into a second formatted data unit according to the formatting specifics for the secondary destination system;
retrieving the uniform resource locator for the secondary destination system from the register if destination systems;
sending the second formatted data unit to the uniform resource locator of the secondary destination system;
receiving a message receipt from the secondary destination system for the second formatted data unit; and
sending the message receipt to the originating system.

19. The method for formatting and distributing electronic data by executing computer-executable instructions stored on a non-transitory computer-readable medium, the method as claimed in claim 18 further comprises the steps of:
providing the formatting specifics for the secondary destination system, wherein the formatting specifics for the secondary destination system contains secondary destination encryption data; and
encrypting the second formatted data unit according to the secondary destination encryption data.

20. The method for formatting and distributing electronic data by executing computer-executable instructions stored on a non-transitory computer-readable medium, the method as claimed in claim 18 further comprises the steps of:
providing the formatting specifics for the secondary destination system, wherein the formatting specifics for the secondary destination system contains anonymization data; and
anonymizing the second formatted data unit according to the anonymization data.
